(19) United States
(12) Patent Application Publication
(10) Pub. No.: US 2016/0218613 A1
(43) Pub. Date: Jul. 28, 2016

(54) INRUSH CURRENT CONTROLLER FOR VOLTAGE REGULATORS

(71) Applicant: Vidatronic, Inc., College Station, TX (US)

(72) Inventors: Faisal Hussien, Cairo (EG); Sameh Ahmed Assem Mostafa Ibrahim, Cairo (EG); Mohamed Mostafa Saber Aboudina, Giza (EG); Mohamed Ahmed Mohamed El-Nozahi, Heliopolis (EG); Moises Emanuel Robinson, Austin, TX (US)

(73) Assignee: Vidatronic, Inc., College Station, TX (US)

(21) Appl. No.: 15/006,671

(22) Filed: Jan. 26, 2016

Related U.S. Application Data
(60) Provisional application No. 62/107,689, filed on Jan. 26, 2015.

(51) Int. Cl. H02M 1/088; H02M 1/32; H02M 1/36

(52) U.S. Cl. CPC H02M 1/088; H02M 1/36; H02M 1/32; H02M 2001/0045

(57) ABSTRACT

Inrush current is a critical, undesirable behavior that results from the uncontrolled start-up or shut-down of voltage regulators. Large inrush currents lead to voltage overshoot at the output node of voltage regulators and this can damage the regulator load, in addition to peak current that can damage the packaging or the regulator itself. Embodiments of the invention introduce methods of inrush current reduction based on voltage reference generation. For example, one method is based on multiple filtered steps of the voltage reference for the voltage regulator. For example, another method is based on creating a voltage reference signal that has a continuous slope starting from zero and ending at zero. Embodiments of the invention reduce or limit the inrush current for sensitive applications.

### BACKGROUND

A voltage regulator is a structure capable of converting a noisy and irregular input voltage level to a clean and constant output voltage level. Based on the conversion technique, voltage regulators can be categorized into switching voltage regulators and linear voltage regulators. A low Drop-Out (LDO) linear voltage regulator is an example of linear voltage regulators, while DC-DC switching converters are examples of switching voltage regulators. Furthermore, DC-DC converters can be divided into several categories, including Buck converters and Boost converters. In particular, a Buck converter is a step-down voltage converter, while a Boost converter is a step-up voltage converter. Throughout this disclosure, the terms “voltage regulator,” “voltage converter,” “regulator,” and “converter” may be used interchangeably depending on the context. Further, the terms “LDO linear voltage regulator” and “LDO” may also be used interchangeably depending on the context.

During startup (i.e., when the input power supply is turned ON, or the Enable signal is activated), voltage regulators are affected by a sudden change in their state. Accordingly, all internal nodes start ramping from their powered down state to reach their final state in order to support a stable output voltage. As a result, it is possible for a large current to start pumping into the output node to reach the steady state as fast as possible. When reaching the final state, the output current does not stop immediately, it continues to increase until the voltage regulator loop senses the new state and starts controlling (e.g. dropping) the output current. This leads to output voltage overshoot. Given this scenario, the output current as well as the output voltage can damage the voltage regulator components and/or the load circuit.

FIG. 1 shows an output voltage waveform (100) observed at an output terminal of a DC-DC switching voltage regulator during start-up without using proper voltage or current controller circuits. This voltage waveform (100) includes a fast ramping voltage rise (101) as a result of the high output current (inrush current) (102). This fast ramp produces a voltage overshoot (103) that depends on the loop dynamics of the regulator circuit. Based on the load and its application, either of these two effects (fast ramping voltage and voltage overshoot) can damage external components that are specified to tolerate much lower voltage ratings for steady state operations.

FIG. 1 also shows that a peak current (104) reaches much higher values than the targeted average load current (105). Since a DC-DC switching voltage regulator has an off-chip output stage; such peak current (104) can destroy both bond wires and external components if not controlled properly. Proper choice of external components and bond wires to tolerate the peak current (104) without component damage will lead to a high-cost solution. Even with this costly solution, this peak current is withdrawn from a separate power supply providing power to the regulator. Thus, this power supply needs to be designed to tolerate this large current (e.g., with small output impedance), otherwise the power input voltage at the power input terminal of the regulator may experience a drop that causes start-up failures.

FIG. 2 shows similar effects as the ones shown in FIG. 1, but for the shut-down process of a DC-DC switching voltage regulator. Similar precautions must be taken to avoid the damage of external components and bond wires.

During shut-down, a current discharge path controls the output voltage slew rate. During the discharge, the Buck converter behaves as a boost circuit causing a voltage peak on the power input terminal (i.e., a circuit node connected to the power output of a separate power supply). This peak can damage the Buck converter and any other circuit attached to the power output of the same power supply. A large input capacitor at the power input terminal may be used to solve this problem.

A controlled start-up and shut-down mechanism for voltage regulators is needed in order to avoid any risk of damaging the regulator, the load, or any off-chip components. Soft-start, soft-stop, inrush controller, and output current control circuits are examples of controlled mechanisms of startup and shutdown for voltage regulators.

Soft-start, soft-stop, and inrush control circuits are circuits that help prevent the voltage overshoots and current peaking that can damage the system during start-up and shut-down. They perform this function either by controlling the output current (inrush current) or by directly controlling the voltage ramp (slew rate) of the output node. Different approaches are introduced in the literature to perform these functions.

In voltage regulators, the output voltage follows a reference voltage (V_{ref}). A common approach used in soft-start architectures is to control the V_{ref} ramp-up during start-up and thus controlling the output ramp irrespective of the control loop speed. The key parameter is the optimum Vref ramp function to eliminate any inrush current peak. Any slope discontinuity in this function will lead to a current peak.

FIG. 3 shows an analog circuit (300) used to control the V_{ref} ramp-up during start-up. The same circuit can be used, as well, for V_{ref} ramp-down during shut-down. In the circuit (300), a soft start controller (301) is used to generate a staircase ramp voltage VREFBYSS (302) used as V_{ref} during start-up. A low-speed oscillator or a fast-speed oscillator with a large counter is needed to achieve the typical hundreds of microseconds of ramp time. Moreover, this piecewise continuous signal has a unit-step derivative function. This unit step function causes a peak in the inrush current which is not desirable.

FIG. 4 shows another analog circuit (400) with a different implementation for a fully continuous linear ramp. It uses a current source (401) to charge a capacitor (402). Similarly, it requires a very large capacitor value to achieve a start-up time in the hundreds of microseconds range. In several implementations this capacitor (402) needs to be off-chip (external) leading to extra cost and an increase in printed circuit board (PCB) area. This solution cannot be used in low cost applications. The generated ramp function still has a discontinuous derivative that causes inrush peak current.

FIG. 5 shows an analog circuit (500) used to control the V_{ref} ramp-up during start-up operation. In the circuit (500), a controlled low pass RC filter (501) is used to smooth out the V_{ref} step function to limit its slope and consequently the resulting inrush current. The voltage reference (V_{ref}) that is generated with this solution has a discontinuous slope function which leads to a large inrush current. To clarify this more, FIG. 6 shows a simplified model for FIG. 5, where the controlled RC filter (501) with its control circuit (502) is replaced with a simple passive RC filter (601), and the bandgap reference (503) is added as the bandgap voltage reference generator (602) with an enable input terminal V₁ (603) to model the power-on effect of the bandgap voltage reference generator (602) At start-up, the enable input (V₁) (603) is activated leading to a step function on V_{BG} (604). The RC filter (601) helps create a filtered version of the bandgap reference voltage V_{BG}_{_}_{RC} (605) with a lower slope. This filtered version still suffers from an abrupt slope change (606) which leads to a peak inrush current (607).

### SUMMARY

Uncontrolled start-up or shut-down of voltage regulators leads to loop disturbances resulting in large inrush current into the regulator load or into the voltage regulator. This large current can damage the regulator components as well as the regulator packaging. Moreover, this large peak current introduces voltage overshoot at the output node which puts the regulator load at risk. Multiple control circuits have been introduced in the literature either to control the pass transistors, to ramp slowly and smoothly voltage references, adding different auxiliary paths, or controlling the output voltage slope via feedback control. This work introduces two new methods of inrush current control (IRCC) based on different voltage reference generation. The first method uses multiple voltage reference steps filtered by a low pass filter. While the second method generates a voltage reference function that has a continuous slope function without any abrupt change in the slope. Implementation examples are presented.

Other aspects of the invention will be apparent from the following detailed description and the appended claims.

### BRIEF DESCRIPTION OF DRAWINGS

The appended drawings are used to illustrate several embodiments of the invention and are not to be considered limiting of its scope, for the invention may admit to other equally effective embodiments.

FIG. 1 shows the behavior of the voltage overshoot and the inrush current ranges at the start-up of a DC-DC switching voltage regulator in the absence of soft-start circuit and current limiting circuits.

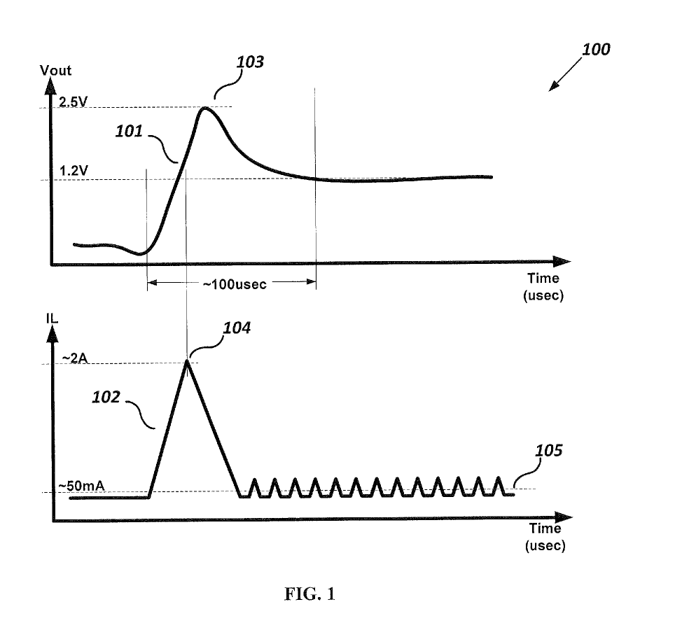

FIG. 2 shows the behavior of the voltage undershoots and the inrush current ranges during shut-down of a DC-DC switching voltage regulator in the absence of soft-stop circuit and current limiting circuits.

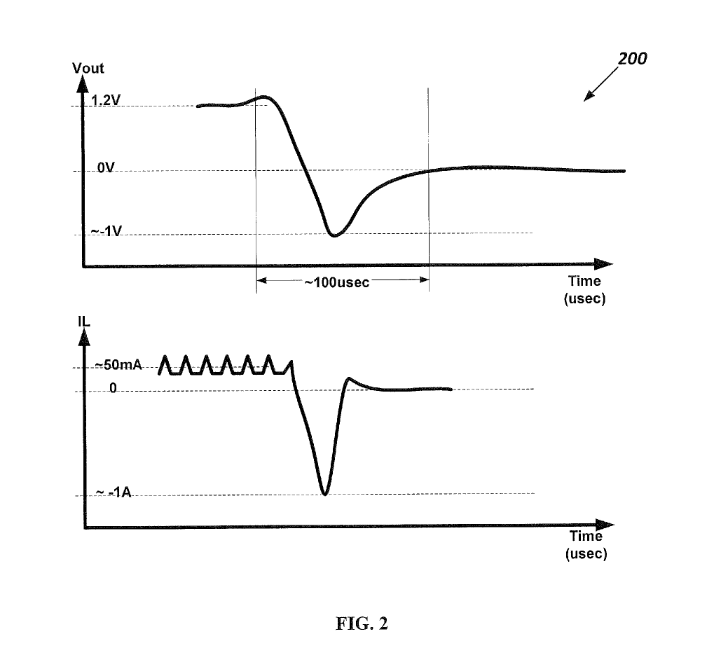

FIG. 3 shows a schematic of an analog circuit to control the V_{ref} signal ramp-up using a piecewise continuous ramp.

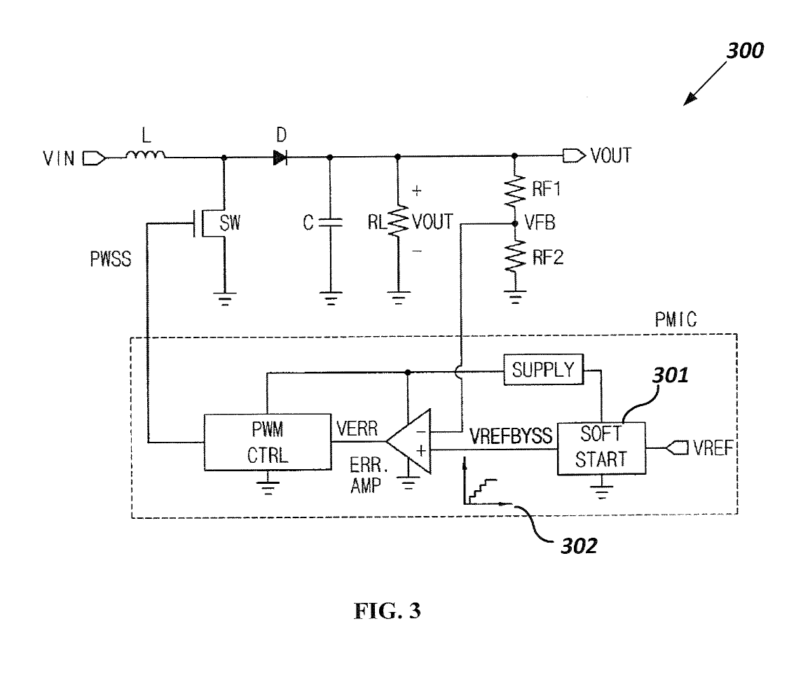

FIG. 4 shows a schematic of an analog circuit to control the V_{ref} signal ramp-up using a current source and a capacitor.

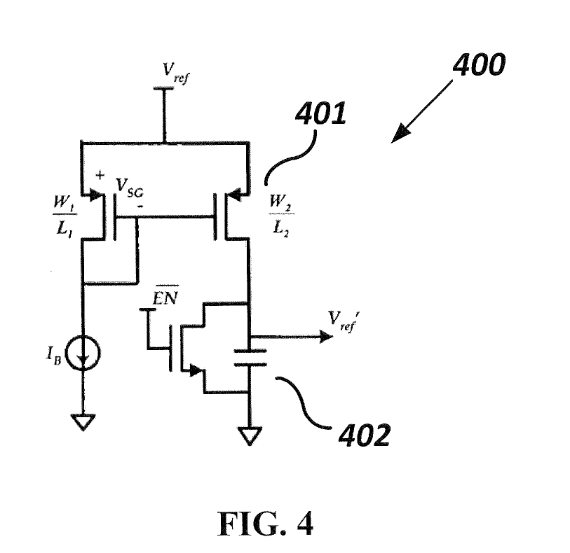

FIG. 5 shows a schematic of an analog circuit to control the V_{ref} signal slope using a low pass filter.

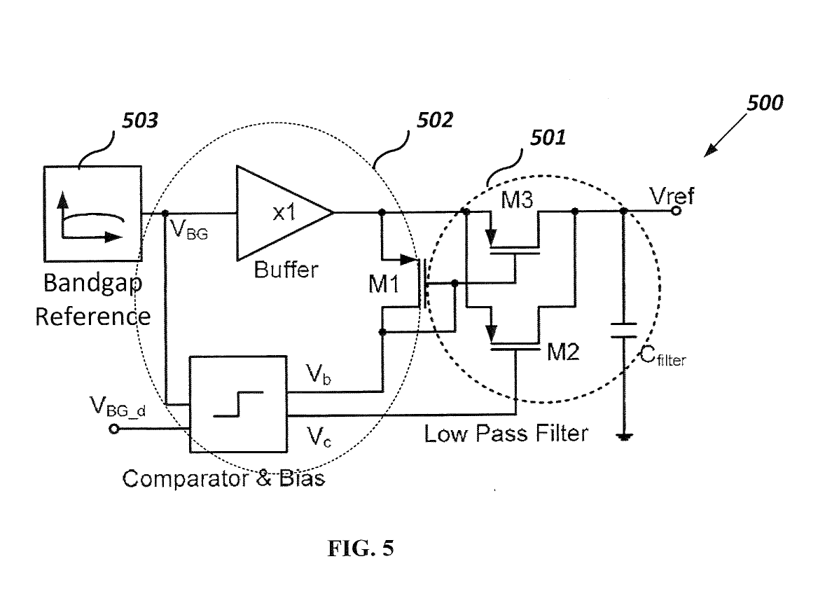

FIG. 6 shows the effect of the sudden slope change of a low pass filter reference output on inrush current behavior.

FIG. 7 shows a block diagram of a modified reference voltage generator based on low pass filtering in accordance with one or more embodiments of the invention.

FIG. 8 shows a sketch of the generated multi-step voltage reference and its effect on the inrush current in accordance with one or more embodiments of the invention.

FIG. 9 shows the slope function for different reference voltage functions.

FIG. 10 shows a sketch of the proposed reference voltage Sigmoid function in a single step and multi-step forms in accordance with one or more embodiments of the invention.

FIG. 11 shows implementation examples of the proposed reference voltage function shown in FIG. 10 in accordance with one or more embodiments of the invention.

FIG. 12 shows a comparison of a voltage regulator inrush current using an RC-filtered reference versus an approximation of Sigmoid voltage reference.

### DETAILED DESCRIPTION

Aspects of the present disclosure are shown in the above-identified drawings and described below. In the description, like or identical reference numerals are used to identify common or similar elements. The drawings are not necessarily to scale and certain features may be shown exaggerated in scale or in schematic in the interest of clarity and conciseness.

Embodiments of the invention relate to an inventive inrush controller circuit for a voltage regulator that reduces or otherwise controls peak inrush currents and voltage overshoots. Accordingly, the output voltage slew rate is controlled during start-up and shut-down to decrease the stress on the external and internal components.

In one or more embodiments of the invention, two inrush current controller circuits (multi-step filtered reference voltage circuit and/or a Sigmoid reference voltage function generator circuit) are used. In one or more embodiments, the inrush current controller circuits are implemented on a microchip, such as a semiconductor integrated circuit. In one or more embodiments, the inventive inrush current controller circuits are implemented in an LDO linear voltage regulator. In one or more embodiments, the inventive inrush current controller circuits are implemented in a voltage regulator. Those skilled in the art, with the benefit of this disclosure will appreciate that the inventive inrush current controller circuits may also be used in other types of voltage regulator circuits.

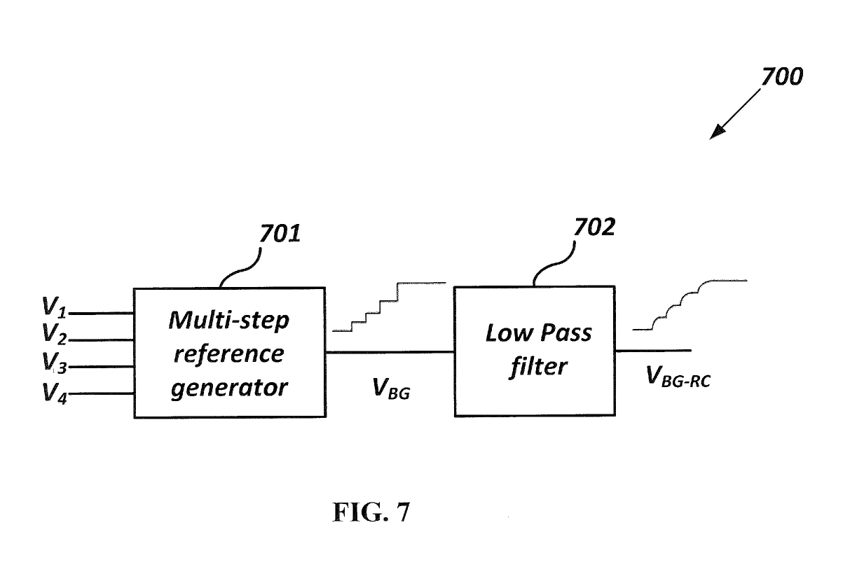

FIG. 7 shows the block diagram of the first invention; a multi-step filtered reference generator (700). In one or more embodiments of the invention, one or more of the modules and elements shown in FIG. 7 may be omitted, repeated, and/or substituted. Accordingly, embodiments of the invention should not be considered limited to the specific arrangements of modules shown in FIG. 7.

In one or more embodiments, a multi-step filtered reference generator (700) is used as an input reference voltage to a voltage regulator and is operated during start-up and/or shut-down procedures.

In one or more embodiments, a multi-step filtered reference generator (700) includes a multi-step reference generator (701) and it is configured to generate a multi-level reference voltage (V_{BG}). This reference voltage is then passed through a low pass filter (702) to reduce its slope. Details of the operation of the circuit (700) are described below.

As shown in FIG. 7, a multi-step reference voltage is generated and filtered through a low pass filter. The multi-step reference generator (701) can have different implementation architectures. For example, a bandgap reference with multiple input control voltages, where the number of the control inputs is proportional to the number of levels required for the reference voltage. This staircase voltage is filtered to reduce its slope with a low pass filter (702).

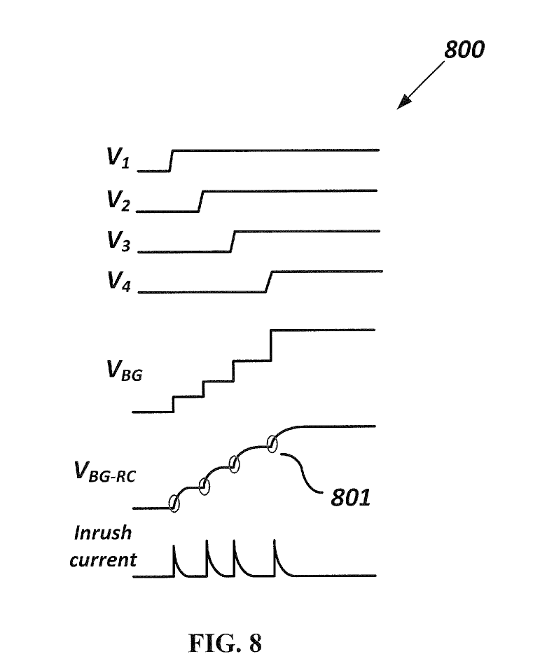

FIG. 8 shows a sketch of the generated voltage reference and its effect on the inrush current. As the number of steps increases, the voltage increment per step decreases, leading to smaller time duration for the slope discontinuity at the start of each step (801). This reduces the inrush current peak significantly, at the expense of increasing the number of inrush current peaks. Reducing the peak value of the inrush current reduces any risk of circuit or component damage. Those skilled in the art, with the benefit of this disclosure, will appreciate that other circuit implementations may also be used without deviating from the spirit of the invention.

Inrush current peaks are not desirable as it may cause disturbances if not handled properly by the intended load. Eliminating the inrush current peaks is possible by choosing the proper reference voltage function.

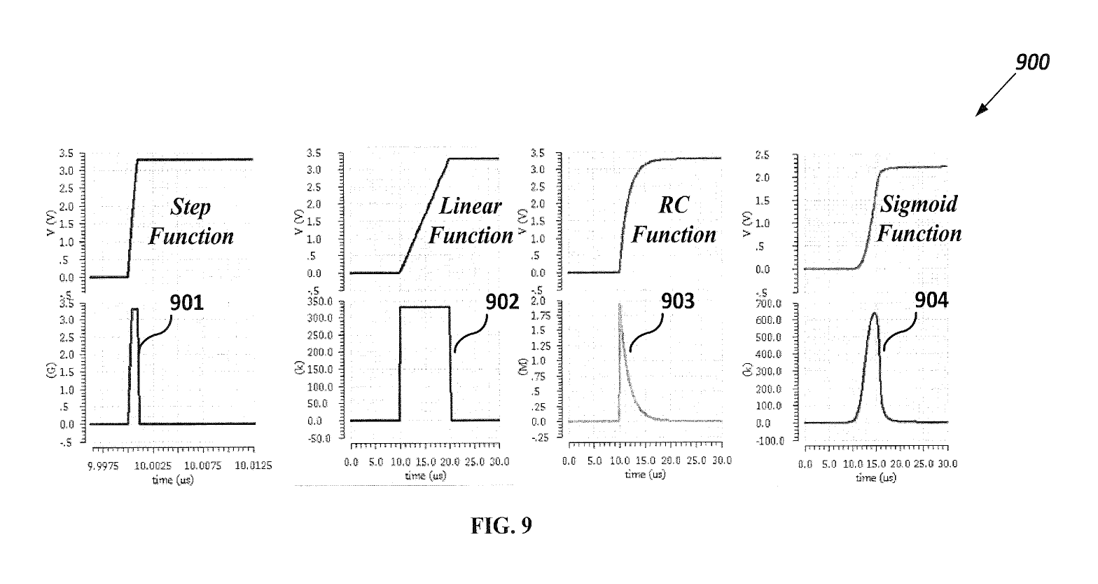

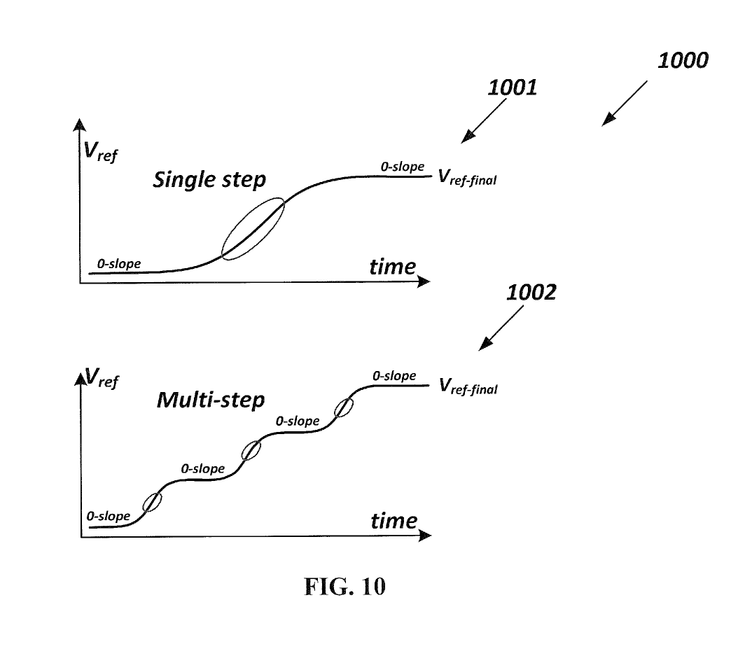

Inrush current peaks result from any abrupt change in the voltage reference slope (derivative). This abrupt change forces the bandwidth-limited voltage regulator to pump more current into the output node to catch up with the new voltage reference slope. FIG. 9 shows different functions for a voltage reference used in a voltage regulator. Each voltage reference function is accompanied by its slope. The Step, Linear and RC functions all have a step change in their slope (derivative) (901, 902, and 903), while the Sigmoid function has a continuous slope function. FIG. 10 shows a sketch of the Sigmoid voltage reference function in a single step (1001) and multi-step form (1002). A multi-step version can be used to maintain a continuous slope as well as a low slew rate feature. In one or more embodiments of the invention, one or more replica of the functions shown in FIG. 10 may be repeated, and/or substituted.

In one or more embodiments, the proposed voltage reference function (1000) is used as an input reference voltage to a voltage regulator and is operated during start-up and/or shut-down procedures. Details of the operation of the circuit (1000) are described below.

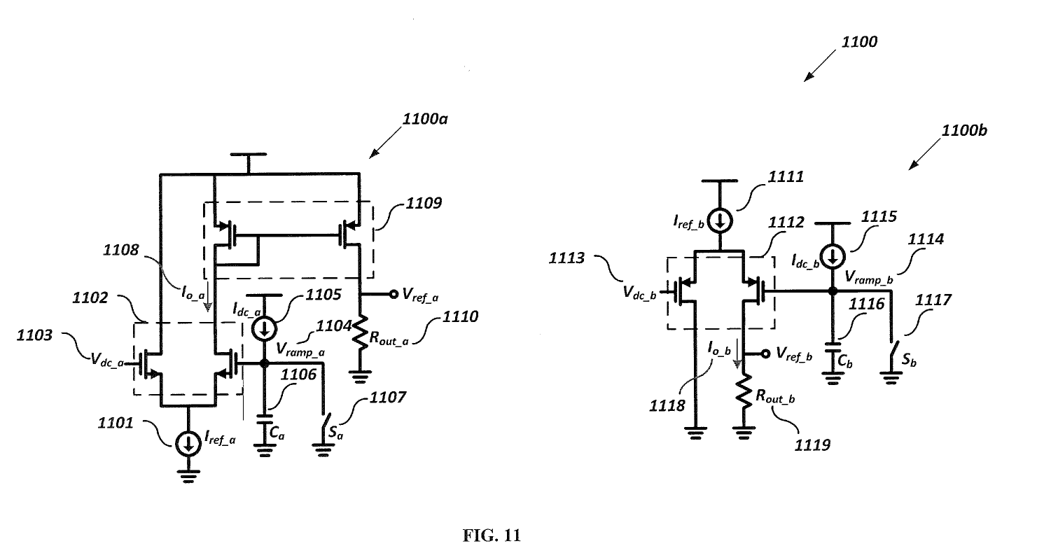

FIG. 11 shows different implementation examples of an approximation of the proposed Sigmoid voltage reference function generator (1000). In one or more embodiments of the invention, one or more of the modules and elements shown in FIG. 11 may be omitted, repeated, and/or substituted. Accordingly, embodiments of the invention should not be considered limited to the specific arrangements of modules shown in FIG. 11.

In one or more embodiments, the voltage reference function generator shown in FIGS. 11 (1100a and 1100b) is used as an input reference voltage to a voltage regulator and is operated during start-up and/or shut-down procedures.

In one or more embodiments, a voltage reference function generator (1100a) has a main reference current source I_{ref}_{_}ₐ (1101). The accuracy of the steady state output reference voltage is proportional to the accuracy of I_{ref}_{_}ₐ (1101). Based on the required accuracy of the generated reference voltage, I_{ref}_{_}ₐ can be generated through a bandgap reference generator, a current reference proportional to the absolute temperature (PTAT), or an accurate current reference using external off-chip components. The current is steered in one of the transistor branches of the differential pair (1102) based on the differential voltage applied to the differential pair. One terminal of the differential pair, V1 is held at a constant voltage V_{dc}_{_}ₐ (1103), while the other terminal, V2, is connected to a ramp voltage, Vᵣₐₘₚ_{_}ₐ (1104), that is swept from a lower voltage level to a higher voltage level linearly using a current source I_{dc}_{_}ₐ (1105) and charging a capacitor Cₐ (1106). The charge/discharge process is controlled with a switch, Sₐ (1107) that is adjusted based on the voltage regulator state (start-up, shut-down, or normal operation). As a result, Iₒ_{_}ₐ (1108) is generated with a continuous slope as given by:

$${I}_{o \_ a} = {K}_{1} \cdot {V}_{ramp \_ a} \sqrt{1 - {( \frac{{V}_{ramp \_ a}}{{K}_{2}} )}^{2}} ,$$

Where K₁ and K₂ are design constants.

The output current is then mirrored to the output node using a transistor current mirror (1109). The current mirror (1109) acts as an optional current direction adjustment block to redirect the current in the required polarity providing a non-zero current gain. Finally, Rₒᵤₜ_{_}ₐ (1110) is used to generate the equivalent voltage function. This implementation example is optimized for low voltage applications. Those skilled in the art, with the benefit of this disclosure, will appreciate that other circuit implementations may also be used without deviating from the spirit of the invention.

In one or more embodiments, a voltage reference function generator (1100b) has a main reference current source I_{ref}_{_}_{b} (1111). Where, the accuracy of the steady state output reference voltage is proportional to the accuracy of I_{ref}_{_}_{b} (1111). The current is steered in one of the transistor branches of the differential pair (1112) based on the differential voltage exerted on the differential pair. One terminal of the differential pair, V1, is held at a constant voltage V_{dc}_{_}_{b} (1113), while the other terminal, V2, is connected to a ramp voltage, Vᵣₐₘₚ_{_}_{b} (1114), that is swept from a lower voltage level to a higher voltage level linearly using a current source I_{dc}_{_}_{b} (1115) charging a capacitor C_{b} (1116). The charge/discharge process is controlled with a switch, S_{b}, (1117) that is adjusted based on the voltage regulator state (start-up, shut-down, or normal operation). As a result, Iₒ_{_}_{b} (1118) is generated with a continuous slope as by:

$${I}_{o \_ b} = {K}_{3} \cdot {V}_{ramp \_ b} \sqrt{1 - {( \frac{{V}_{ramp \_ b}}{{K}_{4}} )}^{2}} ,$$

Where K₃ and K₄ are design constants. Finally, Rout_b (1119) is used to generate the equivalent voltage function. This implementation example is optimized for high accuracy applications.

Those skilled in the art, with the benefit of this disclosure, will appreciate that other circuit implementations may also be used without deviating from the spirit of the invention.

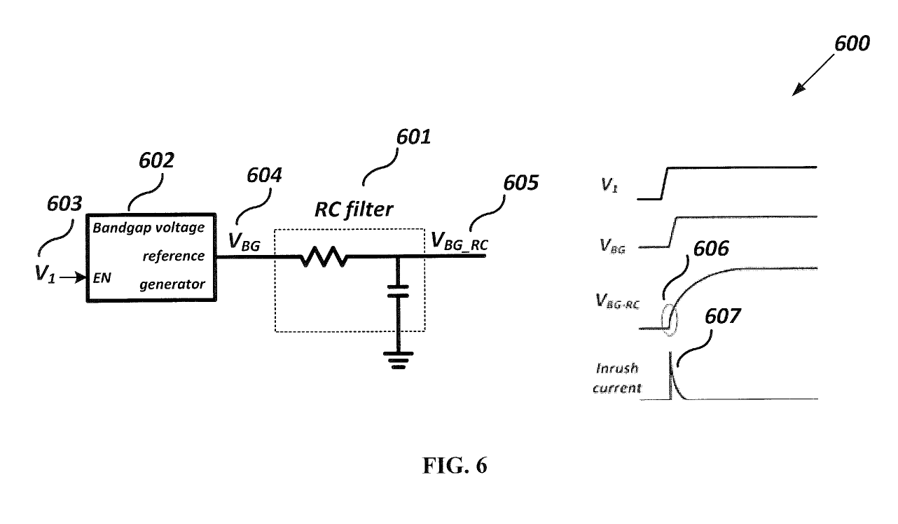

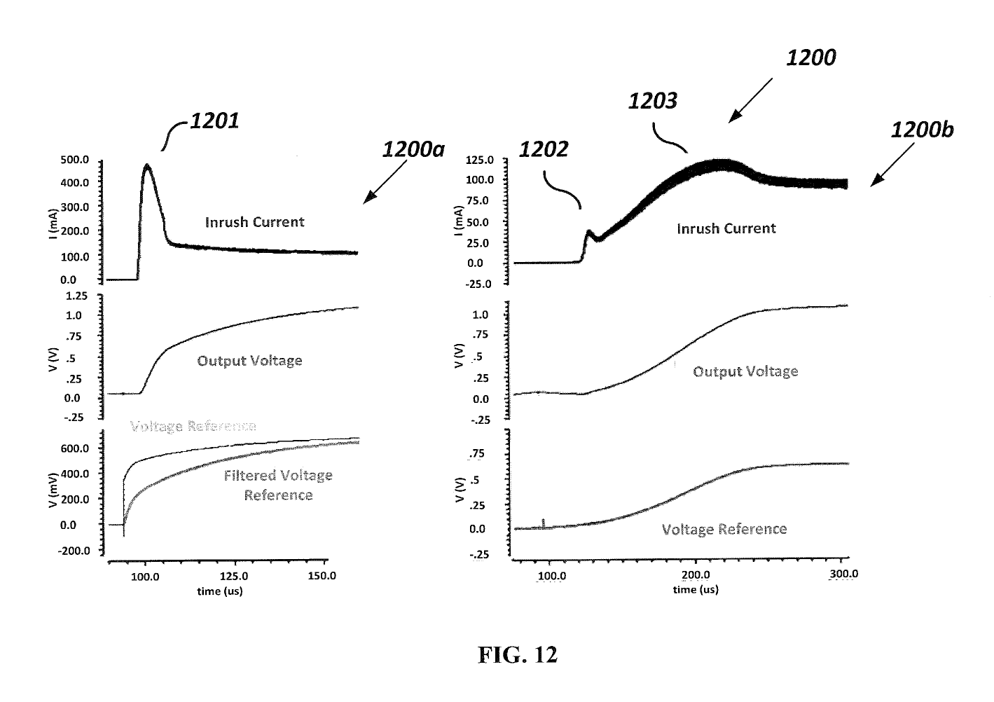

FIG. 12 shows a comparison between: 1) A voltage regulator startup behavior using an RC-filtered voltage reference (1200a) as implemented in FIGS. 6 (600) and 2) A voltage regulator that uses the proposed approximation of a Sigmoid voltage reference (1200b) as implemented in FIG. 11 (1100). A 100 mA load is asserted. The RC-filtered voltage reference caused an inrush current peak of 500 mA (1201), while the proposed voltage reference caused an inrush current peak of 40 mA (1202). An overshoot current of 120 mA (1203) can still be seen due to the voltage regulator dynamics. This can be reduced using a multi-step voltage reference mentioned in FIG. 10 (1002).

What is claimed is:

1. An inrush current controller (IRCC) to control the start-up and shut-down behavior of Voltage Regulators (VR), wherein the IRRC comprises:
a multistep voltage reference generator, and a
a low pass filter.

2. The IRCC of claim 1, wherein:
the voltage regulator comprises at least one selected from a group consisting of linear mode and switching mode voltage regulators.

3. The IRCC of claim 1, wherein:
the multistep voltage reference generator comprises:
an output coupled to the low pass filter input, and
the low pass filter comprises:
an output coupled to the voltage reference input of the VR.

4. The IRCC of claim 1, wherein the multistep voltage reference generator is configured to:
generate staircase voltage levels at startup, starting from zero and ending at the required reference voltage set by the VR.

5. The IRCC of claim 1, wherein:
the low pass filter implementation is at least one selected from a group consisting of passive and active implementations.

6. An inrush current controller (IRCC) to control the start-up and shut-down behavior of Voltage Regulators (VR), wherein the IRCC comprises:
a current reference generator coupled to a transistor differential pair;
a differential pair with its tail current coupled to the current reference; and
a current-to-voltage converter coupled to the differential pair output.

7. The IRCC of claim 6, wherein:
the voltage regulator comprises at least one selected from a group consisting of linear mode and switching mode voltage regulators.

8. The IRCC of claim 6, wherein the differential pair comprises:
a positive terminal coupled to a first voltage reference (V1),
a negative terminal coupled to a second voltage reference (V2),
a positive output coupled to the current-to-voltage converter, and
a negative output coupled to a power supply voltage rail.

9. The differential pair of claim 8, wherein:
V1 and V2 are relatively changing at startup and shutdown to generate a ramping current starting from an initial value and ending at a value proportional to the current reference generator output.

10. The IRCC of claim 6, wherein the current to voltage converter comprises:
an optional current direction adjustment block providing a non-zero current gain, and
a current to voltage element.

11. A method to control the startup and shutdown behavior for Voltage Regulators (VR) comprising:
an open loop inrush current control (IRCC) mechanism performed using a modified voltage reference generator coupled to the VR.

12. The method of claim 11,
wherein the IRCC is achieved through generating the required voltage reference with a continuous slope function coupled to the VR.

13. The method of claim 11,
wherein the IRCC is achieved through generating a filtered multistep voltage reference coupled to the VR.
